(19) United States
(12) Patent Application Publication
(10) Pub. No.: US 2008/0084319 A1
(43) Pub. Date: Apr. 10, 2008

(54) Wakefulness & alertness test device

(76) Inventor: Yue Fan, Ann Arbor, MI (US)

Correspondence Address: Yue Fan, 3330 Goat Fell Ct., Ann Arbor, MI, 48108, US

(21) Appl. No.: 11/542,053

(22) Filed: Oct. 4, 2006

(51) Int. Cl. G08B 23/00; G04B 23/02; G04B 23/00; G08B 1/00

(52) U.S. Cl. 340/575; 340/573.1; 340/309.16; 368/244; 368/262

(57) ABSTRACT

The invention is a device which prevents unwanted manipulation of controls (inputs) by locking (disabling) said controls until the person passes a memory test consisting of a randomly/pseudo-randomly generated pattern. The invention may be a part of another device, or be designed separately and remotely enable/disable the concerned controls.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

Electronic and electrical/mechanical devices (e.g. alarm clock radios, and nuclear power plant control panels) have inputs (e.g. pushbuttons) which are active at all times, or are easily activated. This presents convenience and safety problems due to the fact that it is not desirable to have accessibility to controls before it is reasonably assumed that the operator is at a level of wakefulness and/or alertness to be able to make an informed decision in manipulation of said inputs.

In the case of the alarm clock radio, a person may, in a state of light sleep, turn off the alarm without knowledge of consequences of failing to get out of bed.

Cases with more severe consequences, such as inside of a nuclear power plant control center, an operator who is not sufficiently awake or alert may mistakenly manipulate the wrong controls during the beginning of an otherwise containable emergency situation.

It would be desirable to incorporate a simple (both in terms of design and operation) device, which can help judge whether a subject is awake and alert, and based on the judgment, activate all the inputs (i.e. controls), some inputs, or keep all inputs deactivated on the electronic or electrical/mechanical device (e.g. alarm clock radio).

### BRIEF SUMMARY OF THE INVENTION

The invention is a device which forms a judgment on a person's wakefulness/alertness by testing the said person's short-term memory, and uses the test result to determine whether the controls of another machine to be operated are to be activated. This test of short-term memory is performed by the generation of a random pattern that is then displayed to the person long enough for an average awake person to memorize. Next, the person is expected to repeat back the pattern using inputs which can represent patterns. If the patterns (generated and person repeated) are the same then the controls on the machine to be operated are activated.

This invention benefits the operation of machines that should not be operated before a person is believed to be awake/alert. Prevention of unconscious operation of a machine and manipulation of the controls thereof can add convenience, safety, reliability, productivity, or any combination of the said benefits.

### BRIEF DESCRIPTION OF THE SEVERAL VIEWS OF THE DRAWING

FIG. 1 is an example of an alarm clock radio that has incorporated the invention. In this setup the follow must happen before the clock's control buttons 3 are functional: 1) the user depresses any button 2 which requests that a pseudo-random pattern be generated. 2) the generated pattern is output via lights 1 (i.e. binary pattern converted to light sequence) so that the differently located lights 1 in a line flashing represents the pattern. 3) the user attempts to repeat this sequence via buttons 2 corresponding to the lights 1 (i.e. each placed light 1 has a button 2 directly below). If the user repeated sequence matches that of the generated, then the clock's control buttons 3 are activated. The possible designs and incorporations of a logical controller are not featured in this diagram (FIG. 1).

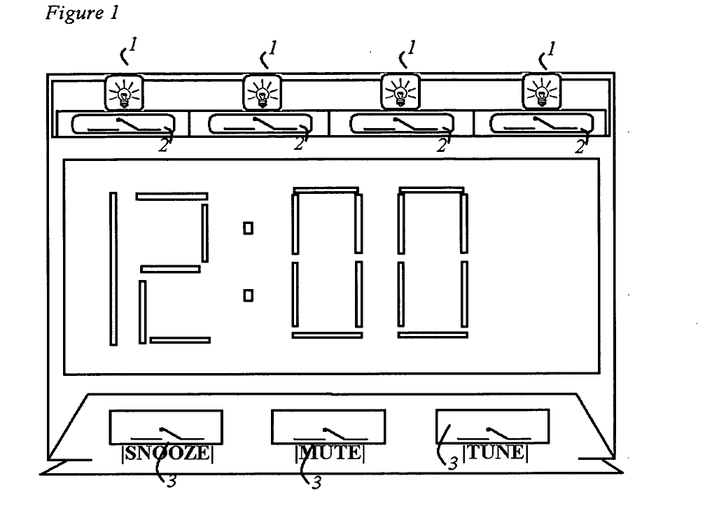

FIG. 2 is a block diagram of the basic components necessary to implement the invention. 1 is the output for the pattern, which, in this case, is represented by numbers and/or other symbols that can be displayed on a 7-segment display. 2 is the input, the user uses to repeat back the displayed pattern. In this case, 2 is a keypad which is capable of inputting all numbers 0-9 and eight other symbols. 4 is the controller that generates the pattern output to 1 and compares that to the repeated pattern input on 2. Matching patterns correlate with a person who is awake/alert enough to memorize and repeat a [pseudo] random pattern. The controller 4 may be integrated into a larger circuitry, or it may be independent and consist of an embedded controller such as a PICMicro® device. 3 is the control panel (of a device which benefits from controls being normally disabled) that is disabled until the controller 4 sends a “control activation” signal, or completes a circuit which control panel 3 requires in order to be active.

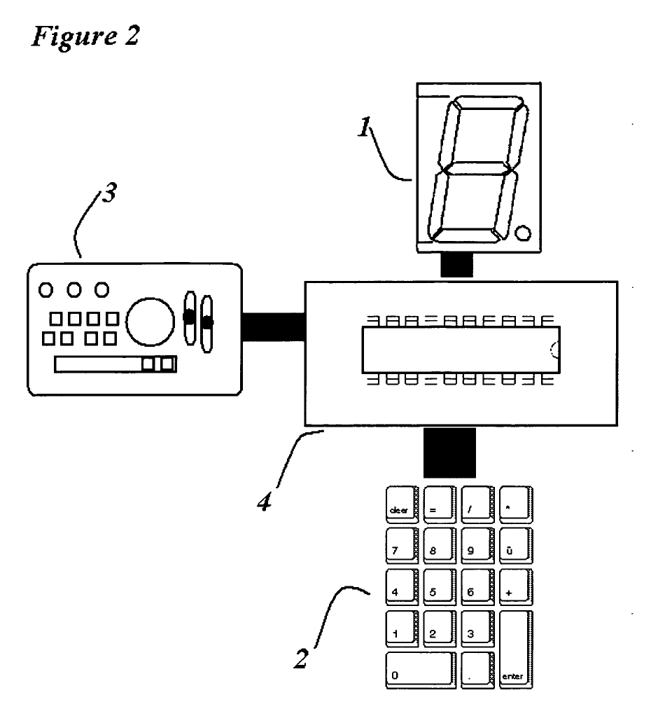

### DETAILED DESCRIPTION OF THE INVENTION

The present invention is a device that judges a person's wakefulness and/or alertness by testing the said person's short-term memory. This test of short-term memory is operationalized first through the generation of a random (or pseudo-random) pattern (by an embedded micro-controller 4, an ASIC, etc) which is then output to the said person (via displays 1, placed lights 1, audio, etc.) for a chosen period of time. Second, the person must attempt to repeat the aforementioned pattern from memory (via inputs associated with possible said outputs, such as pushbuttons 2). Lastly, the generated (and output) pattern is compared (by an embedded micro-controller 4, an ASIC, etc) to that of the person's input.

If the two patterns (the generated and the input by person) are identical, then it is determined to a calculatedly degree of certainty that the person was awake and alert enough to memorize and repeat back the generated pattern. At this point, after it is determined that the person is awake/alert (to a calculatedly degree), the inputs 3(i.e. controls) for the electronic or electrical/mechanical device (e.g. alarm clock radio) are completely or partially activated (e.g. snooze button 3 of alarm clock radio becomes functional).

If the two aforementioned patterns do not match then either all inputs (i.e. controls 3) or a decided portion of inputs on the electronic or electrical/mechanical device (e.g. alarm clock radio) are kept in a disabled state.

Patterns which are easy to repeat by idle trials may be filtered out of use by software algorithms or other means, such that, a pattern will not be able to be successfully repeated by depressing a single button (or other input) in succession (as defined for each implementation, which may range from 2 times to the number of times required to complete a pattern).

With the present invention as a part of the design of devices that have inputs, accidental and unconscious input manipulations are reduced (at a calculatedly rate). This could improve usability, convenience, safety, productivity, or any combination thereof for the said device.

1. A device that tests determines the wakefulness and alertness of a subject by testing the subject's ability to correctly repeat back a randomly or pseudo randomly generated pattern or sequence, such that a correctly repeated pattern or sequence means alertness and an incorrectly repeated pattern or sequence means un-alertness.

2. A device incorporating the device defined in claim 1 that will enable one or more controls of a control panel if the test result defined in claim 1 determines alertness, and disable one or more controls of a control panel if the test result defined in claim 1 determines Un-alertness.

3. The use of device defined in claim 2 to prevent the unconscious or uninformed muting of alarm clocks, including clock radios and multifunction devices, by disabling mute-causing buttons until the human operator is determined to be alert and thus awake.

4. The use of device defined in claim 2 in any other device or that can benefit from having controls that can only be operated by alert people.
